(19) United States
(12) Patent Application Publication
(10) Pub. No.: US 2009/0257537 A1
(43) Pub. Date: Oct. 15, 2009

(54) DATA RECOVERY CIRCUIT OF SEMICONDUCTOR MEMORY APPARATUS THAT MINIMIZES JITTER DURING DATA TRANSMISSION

(76) Inventors: Yong-Ju KIM, Ichon-si (KR); Hae-Rang CHOI, Ichon-si (KR); Oh-Kyong KWON, Seoul (KR); Jun-Yong SONG, Seoul (KR); Min-Seok SHIN, Seoul (KR)

Correspondence Address: LADAS & PARRY LLP, 224 SOUTH MICHIGAN AVENUE, SUITE 1600, CHICAGO, IL, 60604, US

(21) Appl. No.: 12/344,736

(22) Filed: Dec. 29, 2008

(30) Foreign Application Priority Data
Apr. 10, 2008 (KR) 10-2008-0032996

(51) Int. Cl. H04L 7/00

(52) U.S. Cl. 375/354

(57) ABSTRACT

A data recovery circuit that minimizes jitter during data transmission is presented. The data recovery circuit includes a data dividing unit, a data sampling unit, a data selecting unit, and a data recovery unit. The data dividing unit is for dividing external data to generate multiple-division data. The data sampling unit is for sampling the multiple-division data at a first time and a second time to generate sampling data. The data selecting unit is for selecting one of the data sampled at the first time or the second time from the sampling data in accordance to whether the sampling data is transited to output the selected one as selection data. The data recovery unit is for recovering the selection data to internal data in the same logic level as the logic level of the external data.

### CROSS-REFERENCES TO RELATED APPLICATION

The present application claims priority under 35 U.S.C. 119(a) to Korean application number 10-2008-0032996, filed on Apr. 10, 2008, in the Korean Patent Office, which is incorporated by reference in its entirety as if set forth in full.

### BACKGROUND OF THE INVENTION

1. Technical Field

The embodiments described herein relate to a semiconductor memory apparatus and, more particularly, to the data recovery circuit of a semiconductor memory apparatus.

2. Related Art

In general, a signal transmission system transmits and receives data in synchronization with a clock. Unfortunately occasionally a difficulty in correctly transmitting the data in synchronization with the clock can occur. As a result, a data recovery circuit is often provided to perform control so that the recovered data is transmitted and received in synchronization with the clock.

As illustrated in FIG. 1, the data recovery circuit of a common semiconductor memory apparatus includes a clock generating unit 10 and a data determining unit 20.

The clock generating unit 10 compares the phase of input data ‘data_in’ with the phase of a data recovery clock ‘CLK_data’ to determine the phase of the data recovery clock ‘CLK_data’.

The clock generating unit 10 includes a phase comparator 11, a charge pump 12, and an oscillator 13.

The phase comparator 11 compares the phase of the input data ‘data_in’ with the phase of the fed-back data recovery clock ‘CLK_data’.

The charge pump 12 operates in response to the output signal of the phase comparator 11 and outputs a driving voltage to the oscillator 13.

The oscillator 13 generates the data recovery clock ‘CLK_data’ in response to the level of the driving voltage. The oscillator 13 can determine the frequency of the data recovery clock ‘CLK_data’ in accordance with the level of the driving voltage.

The data determining unit 20 determines the logic level of the input data ‘data_in’ using the data recovery clock ‘CLK_data’ and the input data ‘data_in’ as inputs and outputs the result as output data ‘data_out’.

The data recovery circuit of the common semiconductor memory apparatus having the above structure, as illustrated in FIG. 2A, determines the logic value of data in the center of the data. However, as illustrated in FIGS. 2B and 2C, when a jitter component is generated to the center of the data, the jitter component of the data is misunderstood as the data so that the data can be erroneously determined.

### SUMMARY

A data recovery circuit of a semiconductor memory apparatus capable of correctly determining data, even though a jitter component is generated to the center of the data, is described herein.

According to one aspect, there is provided a data recovery circuit of a semiconductor memory apparatus, comprising a data dividing unit for dividing external data to generate multiple-division data, a data sampling unit for sampling the multiple-division data at a first time and a second time to generate sampling data, a data selecting unit for selecting one of the data sampled at the first time or the second time from the sampling data in accordance with whether the sampling data is transited to output the selected one as selection data, and a data recovery unit for recovering the selection data to internal data in the same logic level as the logic level of the external data.

According to another aspect, there is provided a data recovery circuit of a semiconductor memory apparatus, comprising a data sampling unit for sampling data of one bit at a first time and a second time to generate first sampling data and second sampling data and a data selecting unit for comparing a level of the data with a level of previous data to selectively output the first sampling data or the second sampling data.

According to still another aspect, there is provided a data recovery circuit of a semiconductor memory apparatus, comprising a data dividing unit for dividing external data to generate first division data and second division data, a data sampling unit for sampling the first division data at a first time and a second time to generate first sampling data and second sampling data and for sampling the second division data at the first time and the second time to generate third sampling data and fourth sampling data, a data selecting unit for determining whether the first division data is transited to selectively output the first sampling data or the second sampling data as first selection data in accordance with the determination result and for determining whether the second division data is transited to selectively output the third sampling data or the fourth sampling data as second selection data in accordance with the determination result, and a data recovery unit for combining the first selection data with the second selection data to recover the combined data to internal data in the same logic level as the logic level of the external data.

The data recovery circuit of the semiconductor memory apparatus according to the present disclosure determines the position of data in which a large amount of jitter component exists and the position of data in which a small amount of jitter component exist and then, determines the data in the position where the amount of the jitter component is small so that the real effective period of the data can be secured. Therefore, it is possible to improve the reliability of determining the data.

### BRIEF DESCRIPTION OF THE DRAWINGS

The above and other aspects, features and other advantages of the subject matter of the present disclosure will be more clearly understood from the following detailed description taken in conjunction with the accompanying drawings, in which:

FIG. 1 is a block diagram illustrating the data recovery circuit of a conventional semiconductor memory apparatus;

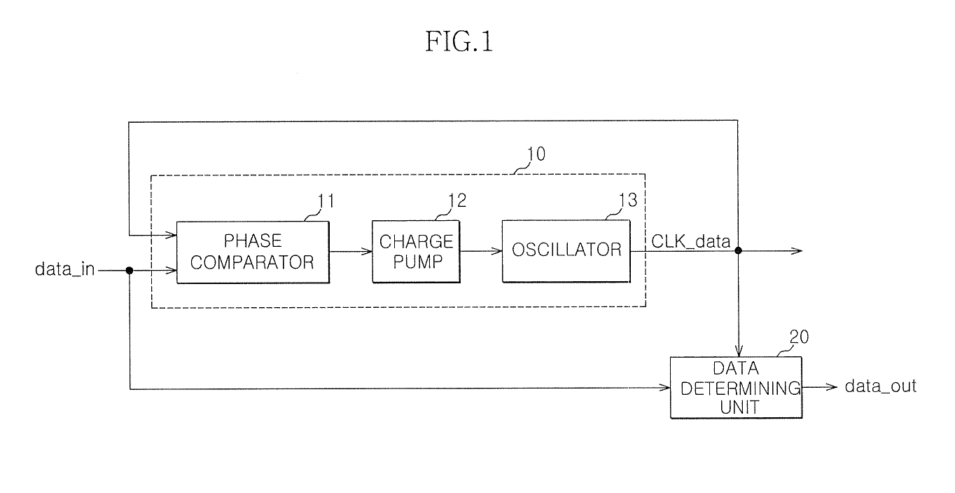

FIG. 2 is a view illustrating the influence of jitter and sampling time in accordance with the level transition of data according to a conventional art;

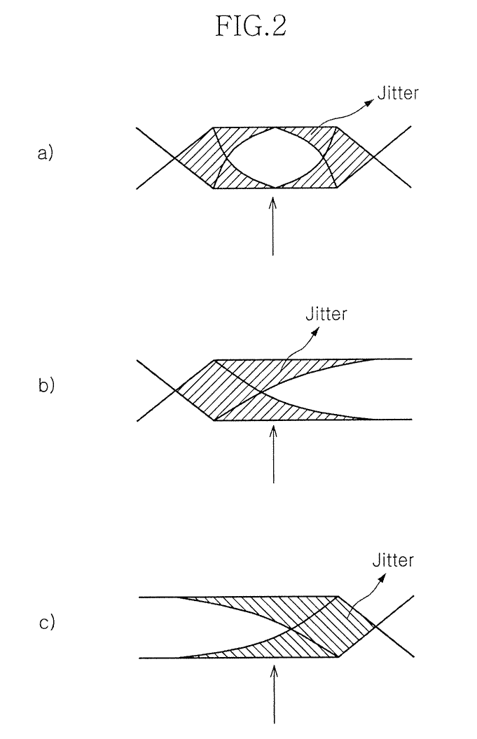

FIG. 3 is a block diagram of the data recovery circuit of a semiconductor memory apparatus according to one embodiment;

FIG. 4 is a block diagram of an example of a data dividing unit of FIG. 3;

FIG. 5 is a timing diagram of an example of a clock dividing unit of FIG. 3;

FIG. 6 is a block diagram of an example of a data sampling unit of FIG. 3;

FIG. 7 is a block diagram of an example of a data selecting unit of FIG. 3;

FIG. 8 is a block diagram of an example of a first selecting unit of FIG. 7;

FIG. 9 is a detailed block diagram of an example of a selection signal generating unit of FIG. 8;

FIG. 10 is a block diagram of an example of a selection data output unit of FIG. 8;

FIG. 11 is a detailed block diagram of an example of a data recovery unit of FIG. 3; and

FIG. 12 is a timing diagram of the data recovery circuit of the semiconductor memory apparatus according to one embodiment of the present disclosure.

### DETAILED DESCRIPTION

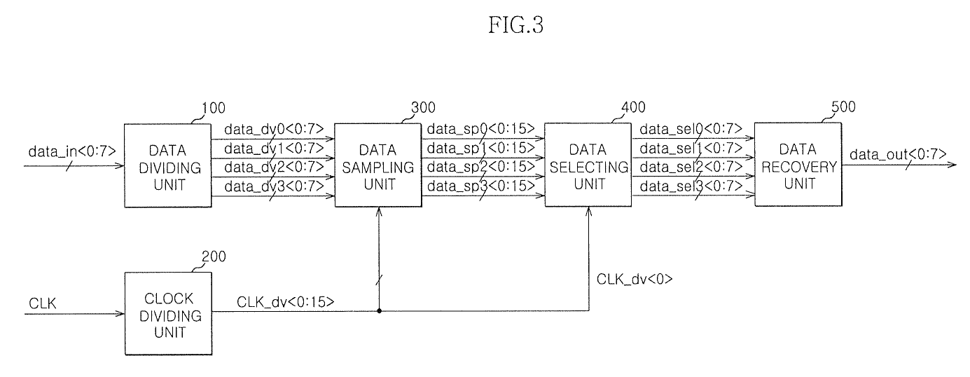

The data recovery circuit of a semiconductor memory apparatus according to one embodiment of the present disclosure, as illustrated in FIG. 3, includes a data dividing unit 100, a clock dividing unit 200, a data sampling unit 300, a data selecting unit 400, and a data recovery unit 500. At this time, the embodiment illustrated in FIG. 3 illustrates that the semiconductor memory apparatus receives data from the outside in units of 8 bits. However, the present disclosure is not limited to the above.

The data dividing unit 100 divides external data ‘data_in<0:7>’ to generate first division data ‘data_dv0<0:7>’, second division data ‘data_dv1<0:7>’, third division data ‘data_dv2<0:7>’, and fourth division data ‘data_dv3<0:7>’.

The clock dividing unit 200 divides the clock ‘CLK’ to generate first to 16^{th} division clocks ‘CLK_dv<0:15>’.

The data sampling unit 300 samples the first to fourth division data items ‘data_dv0<0:7>’, ‘data_dv1<0:7>’, ‘data_dv2<0:7>’, and ‘data_dv3<0:7>’ at predetermined times, that is, a first time and a second time to generate first to fourth sampling data items ‘data_sp0<0:15>’, ‘data sp1<0:15>’, ‘data_sp2<0:15>’, and ‘data sp3<0:15>’. Herein, the first time is understood to mean the time at which the left side of the center of one bit data is sampled and the second time is understood to mean the time at which the right side of the center of one bit data is sampled.

The data selecting unit 400 determines the transition of the first to fourth sampling data items ‘data_sp0<0:15>’, ‘data_sp1<0:15>’, ‘data_sp2<0:15>’, and ‘data_sp3<0:15>’ and outputs first to fourth selection data items ‘data_sel0<0:7>’, ‘data_sel1<0:7>’, ‘data_sel2<0:7>’, and ‘data_sel3<0:7>’ in accordance with the result. In detail, the data selecting unit 400 selects one of the data items sampled at the first or second time from the first to fourth sampling data items ‘data_sp0<0:15>’, ‘data_sp1<0:15>’, ‘data_sp2<0:15>’, and ‘data_sp3<0:15>’ to provide the selected one as the first to fourth selection data items ‘data_sel0<0:7>’, ‘data_sel1<0:7>’, ‘data_sel2<0:7>’, and ‘data_sel3<0:7>’.

The data recovery unit 500 recovers the first to fourth selection data items ‘data_se1-<0:7>’, ‘data_sel1<0:7>’, ‘data_sel2<0:7>’, and ‘data_sel3<0:7>’ to internal data ‘data_out<0:7>’ in the form of the external data input.

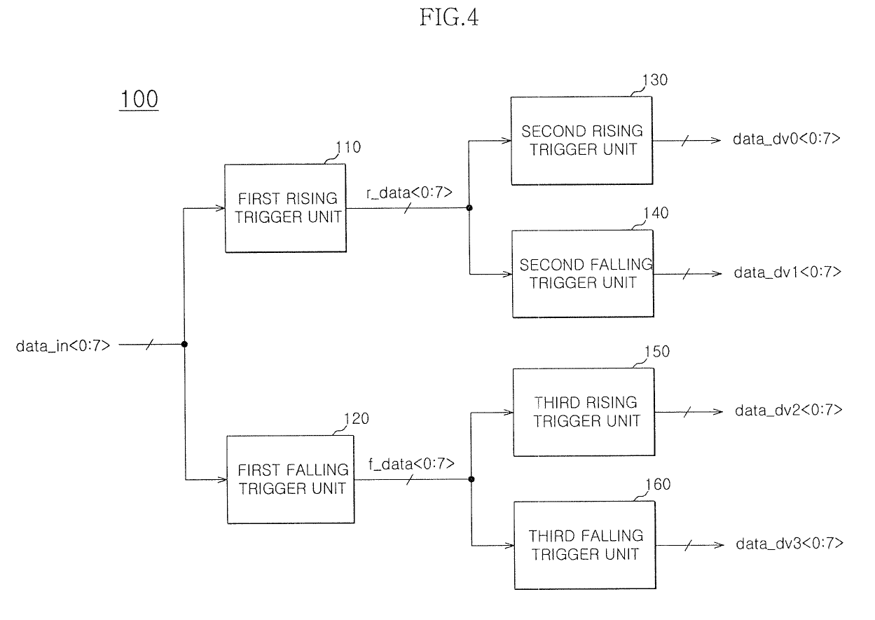

FIG. 4 is a block diagram of the data dividing unit 100 of FIG. 3.

Referring to FIG. 4, the data dividing unit 100 includes first to third rising trigger units 110, 130, and 150 and first to third falling trigger units 120, 140, and 160. The data dividing unit 100 requires the transition point of time of data, that is, rising edge information and falling edge information in order to recover the data.

Therefore, the first rising trigger unit 110 generates rising data ‘r_data<0:7>’ transited at the rising edge time of the external data ‘data_in<0:7>’.

The first falling trigger unit 120 generates falling data ‘f_data<0:7>’ transited at the falling edge time of the external data ‘data_in<0:7>’.

The second rising trigger unit 130 generates first division data ‘data_dv0<0:7>’ transited at the rising edge time of the rising data ‘r_data<0:7>’.

The second falling trigger unit 140 generates second division data ‘data_dv<0:7>’ transited at the falling edge time of the rising data ‘r_data<0:7>’.

The third rising trigger unit 150 generates third division data ‘data_dv2<0:7>’ transited at the rising edge time of the falling data ‘f_data<0:7>’.

The third falling trigger unit 160 generates fourth division data ‘data_dv3<0:7>’ transited at the falling edge time of the falling data ‘f_data<0:7>’.

The rising and falling trigger units 110 to 160 can be simply formed of flip-flops, which is a well-known technology, therefore detailed description thereof will be omitted.

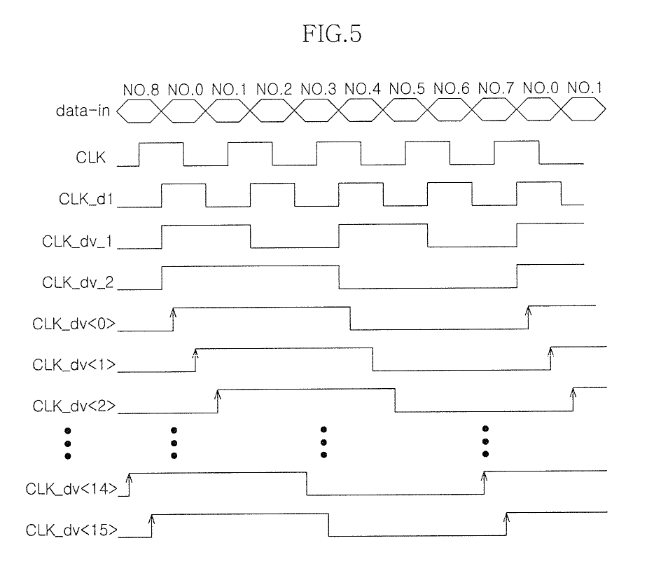

FIG. 5 is a timing diagram illustrating clocks divided by the clock dividing unit 200 of FIG. 3.

Referring to FIG. 5, the clock dividing unit 200 receives the clock ‘CLK’ to generate the first to 16^{th} division clocks ‘CLK_dv<0:15>’. According to the present disclosure, since a semiconductor memory apparatus that transmits and receives data in units of 8 bits is illustrated, in order to sample the data twice at a first time and a second time per each bit, 16 clocks are required.

The external data ‘data_in’ is synchronized with the rising edge time and the falling edge time of the clock ‘CLK’ to be input to the semiconductor memory apparatus. Therefore, the clock ‘CLK’ is transmitted in the center of each bit of the external data ‘data_in’.

The clock dividing unit 200 delays the clock ‘CLK’ to generate a delay clock ‘CLK_dl’ transited at the transition time of the external data ‘data_in’. The delay clock ‘CLK_dl’ is ½ divided to generate a ½ divided clock ‘CLK_dv_1’ and the ½ divided clock ‘CLK_dv_1’ is ½ divided to generate a ¼ divided clock ‘CLK_dv_2’. The ¼ divided clock ‘CLK_dv_2’ is delayed to generate the first to 16^{th} division clocks ‘CLK dv<0:15>’. Therefore, the first division clock ‘CLK_dv<0>’ is transited on the left side of the center of the 0^{th} data of the external data ‘data_in’ to a high level. The second division clock ‘CLK_dv<1>’ is transited on the right side of the center of the external data to a high level. As described above, each two of the first to 16^{th} division clocks ‘CLK_dv<0:15>’ make a pair to be transited on the left and right side of the center of the external data items ‘data_in’<0>’, ‘data_in’<1>’, ‘data_in’<2>’, ‘data_in’<3>’, ‘data_in’<4>’, ‘data_in’<5>’, ‘data_in’<6>’, and ‘data_in’<7>’ of one bit to a high level.

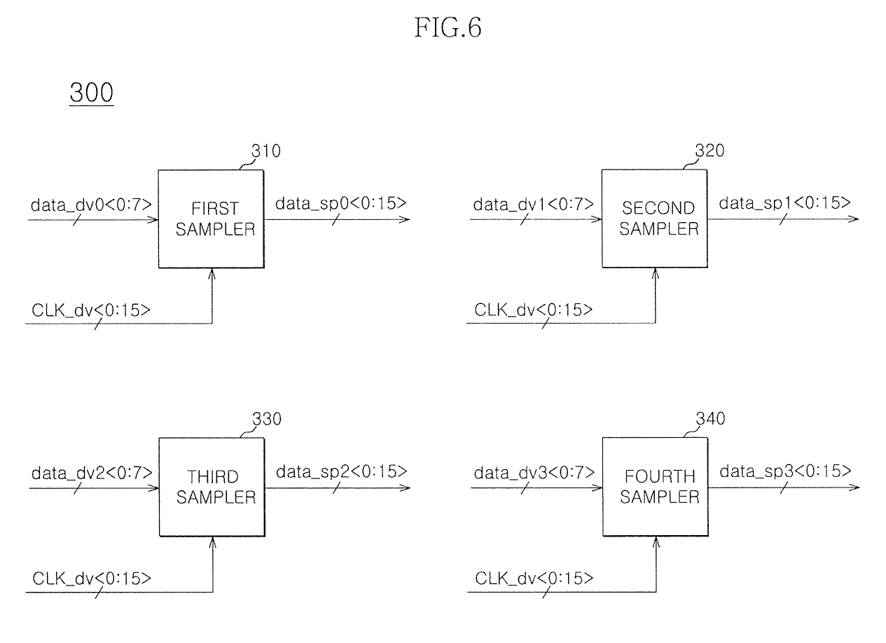

FIG. 6 is a block diagram of the data sampling unit 300 of FIG. 3.

Referring to FIG. 6, the data sampling unit 300 samples the first to fourth division data items ‘data_dv0<0:7>’, ‘data_dv1<0:7>’, ‘data_dv2<0:7>’, and ‘data_dv3<0:7>’ in each bit at the first time and the second time, that is, on the left and right of each bit to output the first to fourth sampling data items ‘data_sp0<0:15>’, ‘data sp1<0:15>’, ‘data_sp2<0:15>’, and ‘data_sp3<0:15>’.

The data sampling unit 300 includes first to fourth samplers 310, 320, 330, and 340. The first sampler 310 samples the first division data ‘data_dv0<0:7>’ at the rising edge times of the first to 16^{th} division clocks ‘CLK_dv<0:15>’ to generate the first sampling data ‘data_sp0<0:15>’.

The second sampler 320 samples the second division data ‘data_dv1<0:7>’ at the rising edge times of the first to 16^{th} division clocks ‘CLK dv<0:15>’ to generate the second sampling data ‘data sp1<0:15>’.

The third sampler 330 samples the third division data ‘data_dv2<0:7>’ at the rising edge times of the first to 16^{th} division clocks ‘CLK_dv<0:15>’ to generate the third sampling data ‘data_sp2<0:15>’.

The fourth sampler 340 samples the fourth division data ‘data_dv3<0:7>’ at the rising edge times of the first to 16^{th} division clocks ‘CLK_dv<0:15>’ to generate the fourth sampling data ‘data sp3<0:15>’. At this time, since the first to fourth samplers 310 to 340 sample two 8 bit data items per each bit, the first to fourth sampling data items ‘data sp0<0:15>’, ‘data_sp1<0:15>’, ‘data sp2<0:15>’, and ‘data sp3<0:15>’ generated by the first to fourth samplers 310 to 340 have 16 bits. Since the sampling circuit for sampling data in accordance with a clock is well-known, detailed description thereof will be omitted.

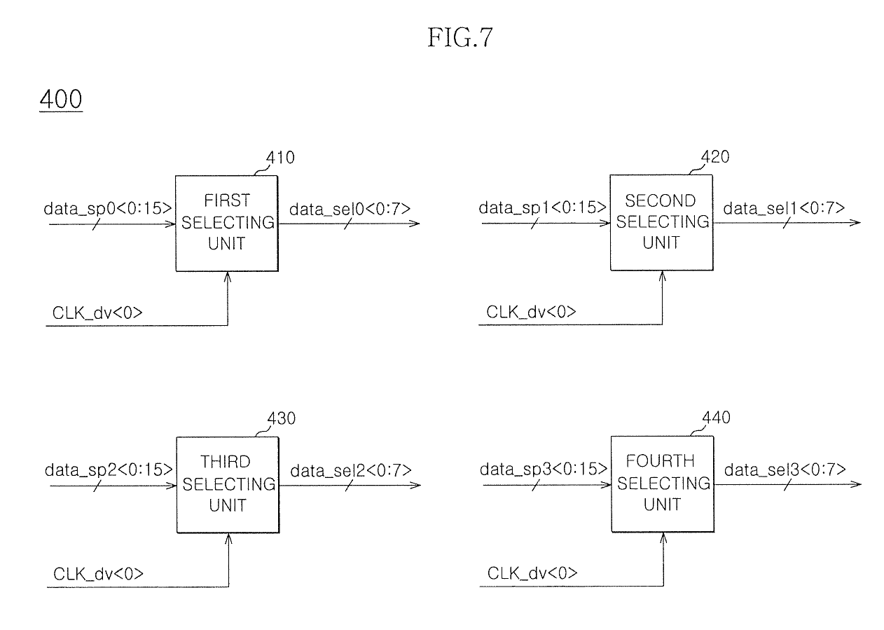

FIG. 7 is a block diagram of the data selecting unit 400 of FIG. 3.

Referring to FIG. 7, the data selecting unit 400 includes first to fourth selecting units 410, 420, 430, and 440.

The first selecting unit 410 determines the transition of each bit data of the first sampling data ‘data_sp0<0:15>’ of 16 bits to generate the first selection data ‘data_sel0<0:7>’ of 8 bits.

The second selecting unit 420 determines the transition of each bit data of the second sampling data ‘data_sp1<0:15>’ of 16 bits to generate the second selection data ‘data_sel1<0:7>’ of 8 bits.

The third selecting unit 430 determines the transition of each bit data of the third sampling data ‘data sp2<0:15>’ of 16 bits to generate the third selection data ‘data_sel2<0:7>’ of 8 bits.

The fourth selecting unit 440 determines the transition of each bit data of the fourth sampling data ‘data sp3<0:15>’ of 16 bits to generate the fourth selection data ‘data_sel3<0:7>’ of 8 bits. At this time, when the selecting units 410 to 440 require the values of 15^{th} and 16^{th} data items of previous sampling data when it is determined whether the 0^{th} and first data items of the sampling data are transited, a circuit for storing the 15^{th} and 16^{th} data items of the previous sampling data to output the stored 15^{th and} 16^{th} data items is required and an instruction clock for storing the 15^{th} and 16^{th} data items of the sampling data to output the stored 15^{th} and 16^{th} data items is required. The instruction clock is one ‘CLK_dv<0>’ of the first to 16^{th} division clocks ‘CLK_dv<0:15>’.

Since the operation principles of the selecting units 410 to 440 are the same, the structures of the selecting units 410 to 440 are similar. Therefore, only the first selecting unit 410 will be described to omit detailed description of the second to fourth selecting units 420 to 440.

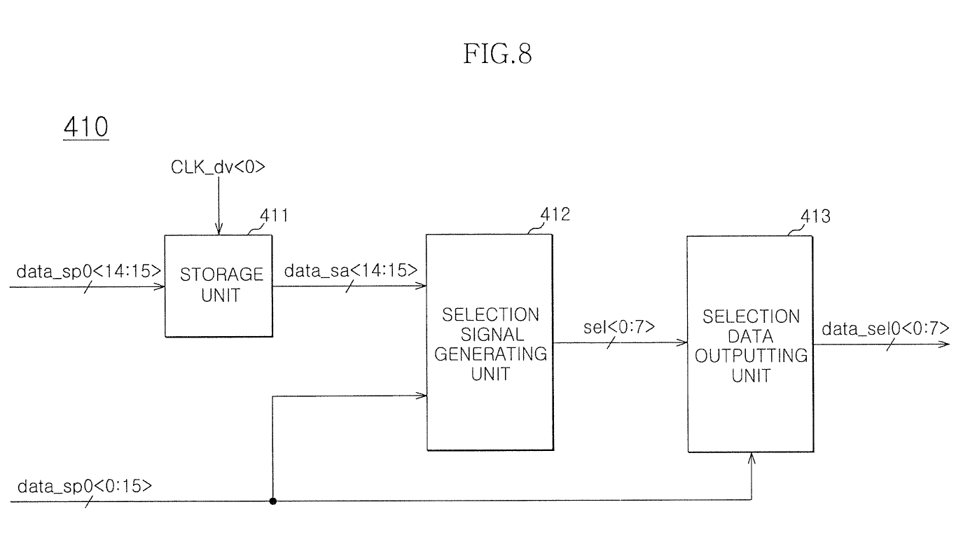

FIG. 8 is a detailed block diagram of the first selecting unit 410 of FIG. 7.

As described in FIG. 8, the first selecting unit 410 includes a storage unit 411, a selection signal generating unit 412, and a selection data outputting unit 413.

The storage unit 411 stores the 15^{th} and 16th data items of the first sampling data ‘data sp0<0:15>’ when the first division clock ‘CLK_dv<0>’ rises and outputs the data stored when the first division clock ‘CLK_dv<0>’ rises next, that is, storage data ‘data_sa<14:15>’. Since the storage unit 411 is commonly used as a latch circuit, detailed description thereof will be omitted.

The selection signal generating unit 412 compares the output of the storage unit 411, that is, the storage data ‘data_sa<14:15>’ with the first sampling data ‘data sp0<0:15>’ to generate first to eighth selection signals ‘sel<0:7>’.

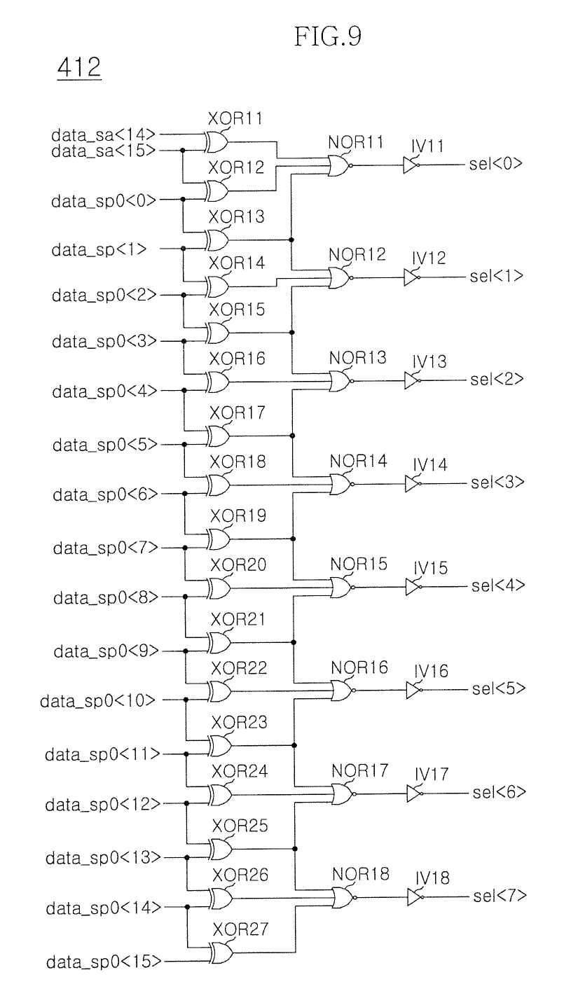

FIG. 9 is a detailed circuit diagram of the selection signal generating unit 412 of FIG. 8.

The selection signal generating unit 412, as illustrated in FIG. 9, includes first to h17^{th} exclusive OR gates XOR11 to XOR27, first to eighth NOR gates NOR11 to NOR18, and first to eighth inverters IV11 to IV18.

The first exclusive OR gate XOR11 receives the storage data ‘data_sa<14:15>’. The second exclusive OR gate XOR12 receives one ‘data_sa<15>’ of the storage data ‘data_sa<14:15>’ and the 0^{th} data ‘data_sp0<0>’ of the first sampling data ‘data_sa0<0:15>’. The third exclusive OR gate XOR13 receives the 0^{th} and first data items ‘data_sp0<0:1>’ of the first sampling data ‘data_sa0<0:15>’. The fourth exclusive OR gate XOR14 receives the first and second data items ‘data sp0<1:2>’ of the first sampling data ‘data_sp0<0:15>’. The fifth exclusive OR gate XOR15 receives the second and third data items ‘data₁₃ sp0<2:3>’ of the first sampling data ‘data_sp0<0:15>’. The sixth exclusive OR gate XOR16 receives the third and fourth data items ‘data_sp0<3:4>’ of the first sampling data ‘data_sp0<0:15>’. The seventh exclusive OR gate XOR17 receives the fourth and fifth data items ‘data sp0<4:5>’ of the first sampling data ‘data_sp0<0:15>’. The eighth exclusive OR gate XOR18 receives the fifth and sixth data items ‘data_sp0<5:6>’ of the first sampling data ‘data_sp0<0:15>’. The ninth exclusive OR gate XOR19 receives the sixth and seventh data items ‘data_sp0<6:7>’ of the first sampling data ‘data sp0<0:15>’. The tenth exclusive OR gate XOR20 receives the seventh and eighth data items ‘data sp0<7:8>’ of the first sampling data ‘data_sp0<0:15>’. The 11^{th} exclusive OR gate XOR21 receives the eighth and ninth data items ‘data sp0<8:9>’ of the first sampling data ‘data sp0<0:15>’. The 12^{th} exclusive OR gate XOR22 receives the ninth and tenth data items ‘data sp0<9:10>’ of the first sampling data ‘data sp0<0:15>’. The 13^{th} exclusive OR gate XOR23 receives the tenth and 11^{th} data items ‘data_sp0<10:11>’ of the first sampling data ‘data sp0<0:15>’. The 14^{th} exclusive OR gate XOR24 receives the 11^{th} and 12^{th} data items ‘data_sp0<11:12>’ of the first sampling data ‘data sp0<0:15>’. The 15^{th} exclusive OR gate XOR25 receives the 12^{th} and 13^{th} data items ‘data sp0<12:13>’ of the first sampling data ‘data sp0<0:15>’. The 16^{th} exclusive OR gate XOR26 receives the 13^{th} and 14^{th} data items ‘data sp0<13:14>’ of the first sampling data ‘data sp0<0:15>’. The 17^{th} exclusive OR gate XOR27 receives the 14^{th} and 15^{th} data items ‘data_sp0<14:15>’ of the first sampling data ‘data sp0<0:15>’. The first NOR gate NOR11 receives the outputs of the first to third exclusive OR gates XOR11 to XOR13. The second NOR gate NOR12 receives the outputs of the third to fifth exclusive OR gates XOR13 to XOR15. The third NOR gate NOR13 receives the outputs of the fifth to seventh exclusive OR gates XOR15 to XOR17. The fourth NOR gate NOR14 receives the outputs of the seventh to ninth exclusive OR gates XOR17 to XOR19. The fifth NOR gate NOR15 receives the outputs of the ninth to 11^{th} exclusive OR gates XOR19 to XOR21. The sixth NOR gate NOR16 receives the outputs of the 11^{th} to 13^{th} exclusive OR gates XOR21 to XOR23. The seventh NOR gate NOR17 receives the outputs of the 13^{th} to 15^{th} exclusive OR gates XOR23 to XOR25. The eighth NOR gate NOR18 receives the outputs of the 15^{th} to 17^{th} exclusive OR gates XOR25 to XOR27. The first inverter IV11 receives the output of the first NOR gate NOR11 to output the first selection signal ‘sel<0>’. The second inverter IV12 receives the output of the second NOR gate NOR12 to output the second selection signal ‘sel<1>’. The third inverter IV13 receives the output of the third NOR gate NOR13 to output the third selection signal ‘sel<2>’. The fourth inverter IV14 receives the output of the fourth NOR gate NOR14 to output the fourth selection signal ‘sel<3>’. The fifth inverter IV15 receives the output of the fifth NOR gate NOR15 to output the fifth selection signal ‘sel<4>’. The sixth inverter IV16 receives the output of the sixth NOR gate NOR16 to output the sixth selection signal ‘sel<5>’. The seventh inverter IV17 receives the output of the seventh NOR gate NOR17 to output the seventh selection signal ‘sel<6>’. The eighth inverter IV18 receives the output of the eighth NOR gate NOR18 to output the eighth selection signal ‘sel<7>’. In general, the exclusive OR gates output signals in a low level when the levels of the two input signals are the same and output signals in a high level when the levels of the two input signals are different from each other. Therefore, in the case of the first selection signal ‘sel<0>’, when the levels of the storage data ‘data_sa<14:15>’ and the 0^{th} and first data items ‘data_sp0<0:1>’ of the first sampling data ‘data sp0<0:15>’ are the same, the first selection signal ‘sel<0>’ is in a low level and, when at least one of the levels of the storage data ‘data_sa<14:15>’ and the 0^{th} and first data items ‘data sp0<0:1>’ of the first sampling data ‘data_sp0<0:15>’ is different from the other, the first selection signal ‘sel<0>’ is in a hiqh level. The levels of the second to eighth selection signals ‘sel<1:7>’ are determined by the same method.

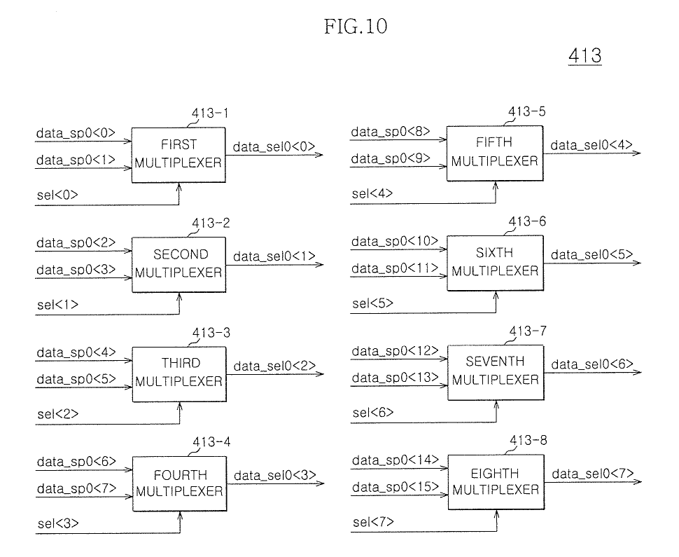

FIG. 10 is a schematic block diagram of the selection data outputting unit 413 of FIG. 8.

Referring to FIG. 10, the selection data outputting unit 413 includes first to eighth multiplexers 413-1 to 413-8.

The first multiplexer 413-1 selects the oth or first data ‘data sp0<0:1>’ of the first sampling data ‘data sp0<0:15>’ in accordance with the level of the first selection signal ‘sel<0>’ to output the selected data as the 0^{th} data ‘data_sel0<0>’ of the first selection data ‘data_sel0<0:7>’. The second multiplexer 413-2 selects the second or third data ‘data_sp0<2:3>’ of the first sampling data ‘data_sp0<0:15>’ in accordance with the level of the second selection signal ‘sel<1>’ to output the selected data as the first data ‘data_sel0<1>’ of the first selection data ‘data_sel0<0:7>’. The third multiplexer 413-3 selects the fourth or fifth data ‘data_sp0<4:5>’ of the first sampling data ‘data sp0<0:15>’ in accordance with the level of the third selection signal ‘sel<2>’ to output the selected data as the second data ‘data_sel0<2>’ of the first selection data ‘data_sel0<0:7>’. The fourth multiplexer 413-4 selects the sixth or seventh data ‘data_sp0<6:7>’ of the first sampling data ‘data_sp0<0:15>’ in accordance with the level of the fourth selection signal ‘sel<3>’ to output the selected data as the third data ‘data_sel0<3>’ of the first selection data ‘data_sel0<0:7>’. The fifth multiplexer 413-5 selects the eighth or ninth data ‘data_sp0<8:9>’ of the first sampling data ‘data sp0<0:15>’ in accordance with the level of the fifth selection signal ‘sel<4>’ to output the selected data as the fourth data ‘data_sel0<4>’ of the first selection data ‘data_sel0<0:7>’. The sixth multiplexer 413-6 selects the tenth or 11^{th} data ‘data_sp0<10:11>’ of the first sampling data ‘data_sp0<0:15>’ in accordance with the level of the sixth selection signal ‘sel<5>’ to output the selected data as the fifth data ‘data_sel0<5>’ of the first selection data ‘data_sel0<0:7>’. The seventh multiplexer 413-7 selects the 12^{th} or 13^{th} data ‘data sp0<12:13>’ of the first sampling data ‘data sp0<0:15>’ in accordance with the level of the seventh selection signal ‘sel<6>’ to output the selected data as the sixth data ‘data_sel0<6>’ of the first selection data ‘data_sel0<0:7>’. The eighth multiplexer 413-8 selects the 14^{th} or 15^{th} data ‘data sp0<14:15>’ of the first sampling data ‘data sp0<0:15>’ in accordance with the level of the eighth selection signal ‘se1<7>’ to output the selected data as the seventh data ‘data_sel0<7>’ of the first selection data ‘data_sel0<0:7>’,

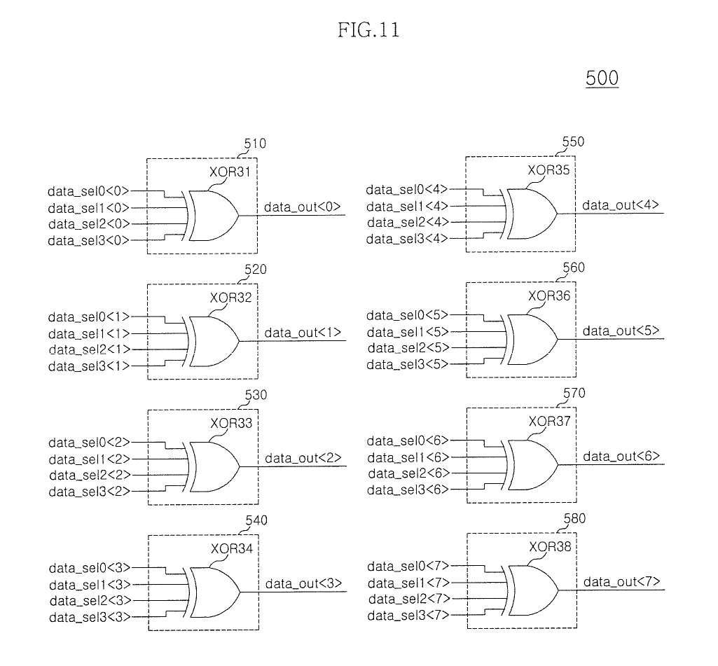

FIG. 11 is a circuit diagram of the data recovery unit 500 of FIG. 3.

Referring to FIG. 11, the data recovery unit 500 generates the internal data ‘data_out<0:7>’ in the form of the external data ‘data_in<0:7>’ by the combination of the first to fourth selection data items ‘data_sel0<0:7>’, ‘data_sel1<0:7>’, ‘data_sel2<0:7>’, and ‘data_sel3<0:7>’.

The data recovery unit 500 includes first to eighth bit recovery units 510 to 580.

The first bit recovery 510 includes an 18^{th} exclusive OR gate XOR31 that receives the Oth data items ‘data_sel0<0>’, ‘data_sel1<0>’, ‘data_sel2<0>’, and ‘data_sel3<0>’ of the first to fourth selection items ‘data_sel0<0:7>’, ‘data_sel1<0:7>’, ‘data_sel2<0:7>’, and ‘data_sel3<0:7>’. At this time, the 18^{th} exclusive OR gate XOR31 outputs the oth data ‘data_out<0>’ of the internal data ‘data_out<0:7>’.

The second bit recovery unit 520 includes a 19^{th} exclusive OR gate XOR32 that receives the first data items ‘data_sel0<1>’, ‘data_sel1<1>’, ‘data_sel2<1>’, and ‘data_sel3<1>’ of the first to fourth selection items ‘data_sel0<0:7>’, ‘data_sel1<0:7>’, ‘data_sel2<0:7>’, and ‘data_sel3<0:7>’. At this time, the 19^{th} exclusive OR gate XOR32 outputs the first data ‘data_out<1>’ of the internal data ‘data_out<0:7>’.

The third bit recovery unit 530 includes a 20^{th} exclusive OR gate XOR33 that receives the second data items ‘data_sel0<2>’, ‘data_sel1<2>’, ‘data_sel2<2>’, and ‘data_sel3<2>’ of the first to fourth selection items ‘data_sel0<0:7>’, ‘data_sel1<0:7>’, ‘data_sel2<0:7>’, and ‘data_sel3<0:7>’. At this time, the 20^{th} exclusive OR gate XOR33 outputs the second data ‘data_out<2>’ of the internal data ‘data_out<0:7>’.

The fourth bit recovery unit 540 includes a 21^{st} exclusive OR gate XOR34 that receives the third data items ‘data_sel0<3>’, ‘data_sel1<3>’, ‘data_sel2<3>’, and ‘data_sel3<3>’ of the first to fourth selection items ‘data_sel0<0:7>’’, ‘data_sel1<0:7>’, ‘data_sel2<0:7>’, and ‘data_sel3<0:7>’. At this time, the 21^{st} exclusive OR gate XOR34 outputs the third data ‘data_out<3>’ of the internal data ‘data_out<0:7>’.

The fifth bit recovery unit 550 includes a 22^{nd} exclusive OR gate XOR35 that receives the fourth data items ‘data_sel0<4>’, ‘data_sel1<4>’, ‘data_sel2<4>’, and ‘data_sel3<4>’ of the first to fourth selection items ‘data_sel0<0:7>’, ‘data_sel1<0:7>’, ‘data_sel2<0:7>’, and ‘data_sel3<0:7>’. At this time, the 22^{nd} exclusive OR gate XOR35 outputs the fourth data ‘data_out<4>’ of the internal data ‘data_out<0:7>’.

The sixth bit recovery unit 560 includes a 23^{rd} exclusive OR gate XOR36 that receives the fifth data items ‘data_sel0<5>’, ‘data_sel1<5>’, ‘data_sel2<5>’, and ‘data_sel3<5>’ of the first to fourth selection items ‘data_sel0<0:7>’, ‘data_sel1<0:7>’, ‘data_sel2<0:7>’, and ‘data_sel3<0:7>’. At this time, the 23^{rd} exclusive OR gate XOR36 outputs the fifth data ‘data_out<5>’ of the internal data ‘data_out<0:7>’.

The seventh bit recovery unit 570 includes a 24^{th} exclusive OR gate XOR37 that receives the sixth data items ‘data_sel0<6>’, ‘data_sel1<6>’, ‘data_sel2<6>’, and ‘data_sel3<6>’ of the first to fourth selection items ‘data_sel0<0:7>’, ‘data_sel1<0:7>’, ‘data_sel2<0:7>’, and ‘data_sel3<0:7>’. At this time, the 24^{th} exclusive OR gate XOR37 outputs the sixth data ‘data_out<6>’ of the internal data ‘data_out<0:7>’.

The eighth bit recovery unit 580 includes a 25^{th} exclusive OR gate XOR38 that receives the seventh data items ‘data_sel0<7>’, ‘data_sel1<7>’, ‘data_sel2<7>’, and ‘data_sel3<7>’ of the first to fourth selection items ‘data_sel0<0:7>’, ‘data_sel1<0:7>’, ‘data_sel2<0:7>’, and ‘data_sel3<0:7>’. At this time, the 25^{th} exclusive OR gate XOR38 outputs the seventh data ‘data_out<7>’ of the internal data ‘data_out<0:7>’.

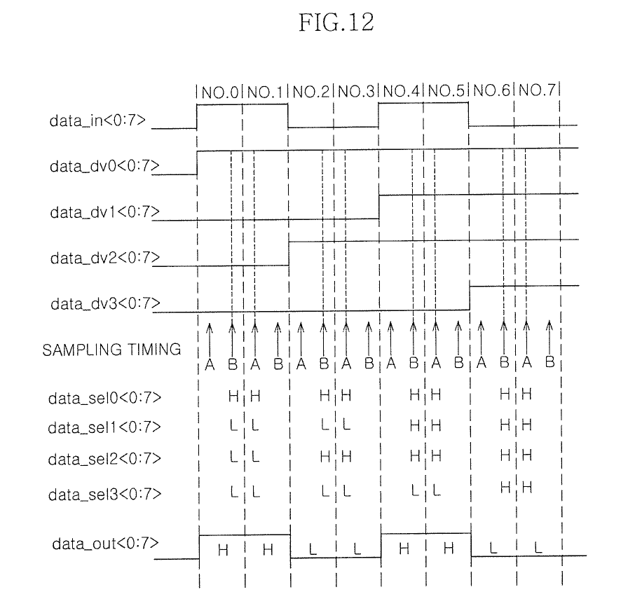

FIG. 12 is a timing diagram illustrating the operation of the data recovery circuit of the semiconductor memory apparatus of FIG. 3. Referring to FIGS. 3 to 12, the operation of the data recovery circuit of the semiconductor memory device will be described as follows. [0084] The serialized external data ‘data_in<0:7>’ is input to the data recovery circuit according to the present disclosure. The data dividing unit 100 divides the external data ‘data_in<0:7>’ to generate the first to fourth division data items ‘data_dv0<0:7>’, ‘data_dv1<0:7>’, ‘data_dv2<0:7>’, and ‘data_dv3<0:7>’.

The data sampling unit 300 samples the data on the left side (A) and on the right side (B) of the center of each bit of the first to fourth division data items ‘data_dv0<0:7>’, ‘data_dv1<0:7>’, ‘data_dv2<0:7>’, and ‘data_dv3<0:7>’. (represented by arrows in FIG. 12).

The data selecting unit 400 selects the data remote from the position where the sampled data is transited to output the selected data. For example, when the number 1 data and the number 2 data are described, in the case where the number 1 data is compared with the number 0 data! since no data is not transited between the two data items, the data sampled on the left (A) of the number 1 data is selected. In the case where the number 2 data is compared with the number 1 data, since a transition is performed, the data sampled on the right (B) of the number 2 data is selected (represented by a thin dot lines in FIG. 12). That is, when the sampling values of the number 0 data and the number 1 data are different from each other, a selection signal ‘sel<i>’ is set in a high level and, when the sampling values of the number 0 data and the number 1 data are the same, the selection signal ‘sel<i>’ is set in a low level. When the selection signal ‘sel<i>’ is set in the high level, the data sampled on the right (B) of the data items sampled on the left (A) and on the right (B) is output as selection data ‘data_sel. On the other hand, when the selection signal ‘sel<i>’ is set in the low level, the data sampled on the left (A) of the data items sampled on the left (A) and on the right (B) is output as the selection data ‘data_sel’.

The data recovery unit 500 combines the values of the bits of the first to fourth selection data items ‘data_sel0<0:7>’, ‘data_sel1<0:7>’, ‘data sel2<0:7>’, and ‘data_sel3<0:7>’ selected by the data selecting unit 400 with each other to output the internal data ‘data_out<0:7>’ in the form of the external data ‘data_in<0:7>’. The data recovery unit 500 determines the bit value of the internal data ‘data_out<0:7>’ in accordance with the number of high levels of the corresponding bits of the first to fourth selection data items ‘data_sel0<0:7>’, ‘data_sel1<0:7>’, ‘data_sel2<0:7>’, and ‘data_sel3<0:7>’. For example, when the first data items of the first to fourth selection data items ‘data_sel0<0:7>’, ‘data_sel1<0:7>’, ‘data_sel2<0:7>’, and ‘data_sel3<0:7>’ are described, the number of high levels is odd. In addition, when the second data items are described, the number of high levels is even. When the number of high levels is odd, the bit value of the corresponding internal data is in a high level and, when the number of high levels is even, the bit value of the corresponding internal data is in a low level.

When the number of high levels of the bits of the first to fourth selection data items ‘data_sel0<0:7>’, ‘data_sel1<0:7>’, ‘data_sel2<0:7>’, and ‘data_sel3<0:7>’ are described, it is noted that the number of high levels of the oth data items is odd, that the number of high levels of the first data items is odd, that the number of high levels of the second data items is even, that the number of high levels of the third data items is even, that the number of high levels of the fourth data items is odd, that the number of high levels of the fifth data items is odd, that the number of high levels of the sixth data items is even, and that the number of high levels of the seventh data items is even.

Therefore, the 0^{th} data of the internal data ‘data_out<0:7>’ is in a high level, the first data of the internal data ‘data_out<0:7>’ is in a high level, the second data of the internal data ‘data_out<0:7>’ is in a low level, the third data of the internal data ‘data_out<0:7>’ is in a low level, the fourth data of the internal data ‘data_out<0:7>’ is in a high level, the fifth data of the internal data ‘data_out<0:7>’ is in a high level, the sixth data of the internal data ‘data_out<0:7>’ is in a low level, and the seventh data of the internal data ‘data_out<0:7>’ is in a high level.

As a result, the internal data ‘data_out<0:7>’ can be recovered to the same data value as the external data ‘data_in<0:7>’.

In addition, according to the present disclosure, the input external data is sampled on the left and right sides of the center of each bit and the sampling data remote from the position where each bit is transited is output as the internal data so that the influence of jitter in accordance with the transition of the data value can be reduced. In other words, the effective period of the data is secured to stably determine the data. Therefore, according to the present disclosure, the external data is multiple-divided to determine the data so that the reliability of determining the data can be improved.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. A data recovery circuit of a semiconductor memory apparatus, comprising:
a data dividing unit configured to generate multiple-division data by dividing external data;
a data sampling unit configured to generate sampling data by sampling the multiple-division data at a first time and at a second time;
a data selecting unit configured to select and to transit one of the sampling data at the first time or at the second time from the sampling data as a selection data; and
a data recovery unit for recovering the selection data into a logic level of in an internal data to match that of the external data.

2. The data recovery circuit of claim 1, wherein the first time is different from the second time.

3. The data recovery circuit of claim 1, wherein the multiple-division data comprises first division data, second division data, third division data, and fourth division data, and
wherein the data dividing unit generates a rising data transited at a rising edge time of the external data, a falling data transited at a falling edge time of the external data, the first division data transited at a rising edge time of the rising data, the second division data transited at a falling edge time of the rising data, the third division data transited at a rising edge time of the falling data, and the fourth division data transited at a falling edge time of the falling data.

4. The data recovery circuit of claim 3, wherein the data dividing unit comprises:
a first rising trigger unit for generating the rising data in response to the external data;
a first falling trigger unit for generating the falling data in response to the external data;
a second rising trigger unit for generating the first division data in response to the rising data;
a second falling trigger unit for generating the second division data in response to the rising data;
a third rising trigger unit for generating the third division data in response to the falling data; and
a third falling trigger unit for generating the fourth division data in response to the falling data.

5. The data recovery circuit of claim 1,
wherein the multiple-division data comprises first division data, second division data, third division data, and fourth division data, and
wherein the data sampling unit comprises:
a first sampler generating the first sampling data by sampling the first division data at the first time and the second time;
a second sampler generating the second sampling data by sampling the second division data at the first time and the second time;
a third sampler generating the third sampling data by sampling the third division data at the first time and the second time; and
a fourth sampler generating the fourth sampling data by sampling the fourth division data at the first time and the second time.

6. The data recovery circuit of claim 1, wherein the sampling data comprises first sampling data, second sampling data, third sampling data, and fourth sampling data, and
wherein the data selecting unit comprises:
a first selecting unit for determining whether the first sampling data is to select and to transit one of the data sampled at the first time or the second time from the first sampling data as the first selection data;
a second selecting unit for determining whether the second sampling data is to select and to transit one of the data sampled at the first time or the second time from the second sampling data as the second selection data;
a third selecting unit for determining whether the third sampling data is to select and to transit one of the data sampled at the first time or the second time from the third sampling data as the third selection data; and
a fourth selecting unit for determining whether the fourth sampling data is to select and to transit one of the data sampled at the first time or the second time from the fourth sampling data as the fourth selection data.

7. The data recovery circuit of claim 6, wherein each of the first to fourth selecting units compares a value of previous sampling data with a value of current sampling data to selectively output data sampled at the first time or the second time from the current sampling data in accordance to a generated selection signal.

8. The data recovery circuit of claim 7, wherein each of the first to fourth selecting units comprises:
a storage unit configured to store previous sampling data;
a selection signal generating unit configured to generate the selection signal for use in comparing an output of the storage unit with a value of the current sampling data; and
a selection data outputting unit configured to output the selected sampling data, in accordance to the selection signal, by selecting data sampled at the first time or the second time from the current sampling data.

9. The data recovery circuit of claim 8, wherein the selection signal generating unit determines a level of the selection signal in accordance to whether the output of the storage unit is equal to the value of the current sampling data.

10. The data recovery circuit of claim 9, wherein the selection signal generating unit comprises exclusive OR gates having the output of the storage unit and the current sampling data as inputs.

11. The data recovery circuit of claim 8, wherein the selection data outputting unit comprises a multiplexer for selectively outputting the data sampled at the first time or outputting the data sampled at the second time in accordance to the level of the selection signal.

12. The data recovery circuit of claim 1, wherein the selection data comprises first selection data, second selection data, third selection data, and fourth selection data, and
wherein the data recovery unit generates the internal data by a combination of a first selection data items, a second selection data item, a third selection data item, and a fourth selection data item.

13. The data recovery circuit of claim 12, wherein the data recovery unit comprises exclusive OR gates having the first to fourth selection data items as inputs.

14. A data recovery circuit of a semiconductor memory apparatus, comprising:
a data sampling unit configured to generate first sampling data and second sampling data for sampling data of one bit at a first time and at a second time; and
a data selecting unit configured to selectively output the first sampling data or the second sampling data by comparing a level of the data with a level of previous data.

15. The data recovery circuit of claim 14, wherein the data sampling unit samples a left side of a center of the data to generate the first sampling data and samples a right side of the center of the data to generate the second sampling data.

16. The data recovery circuit of claim 14, wherein the data selecting unit compares the level of the data with the level of the previous data to generate a selection signal and selectively outputs the first sampling data or the second sampling data in response to the selection signal.

17. A data recovery circuit of a semiconductor memory apparatus, comprising:
a data dividing unit configured to generate first division data and second division data by dividing external data;
a data sampling unit for sampling the first division data at a first time and a second time to generate first sampling data and second sampling data and for sampling the second division data at the first time and the second time to generate third sampling data and fourth sampling data;
a data selecting unit for determining whether the first division data is transited to selectively output the first sampling data or the second sampling data as a first selection data and for determining whether the second division data is transited to selectively output the third sampling data or the fourth sampling data as a second selection data; and
a data recovery unit for combining the first selection data with the second selection data to recover a combined data to internal data having a logic level identical to that of the external data.

18. The data recovery circuit of claim 17, wherein the data dividing unit generates the first division data transited at a rising edge time of the external data and the second division data transited at a falling edge time of the external data.

19. The data recovery circuit of claim 17, wherein the data sampling unit samples the first division data on a left side of a center of the first division data to generate the first sampling data, samples the first division data on a right side of the center of the first division data to generate the second sampling data, samples the second division data on a left side of a center of the second division data to generate the third sampling data, and samples the second division data on a right side of the center of the second division data to generate the fourth sampling data.

20. The data recovery circuit of claim 17, wherein the data selecting unit compares a level of the first division data with a level of a previous first division data to generate a first selection signal and to selectively output the first sampling data or the second sampling data as the first selection data in response to the first selection signal and compares a level of the second division data with a level of previous second division data to generate the second selection signal and to selectively output the third sampling data or the fourth sampling data as the second selection data in response to the second selection signal.

21. The data recovery circuit of claim 17, wherein the data recovery unit generates the internal data in a high level when a number of high levels is odd among logic levels of first and second selection data items and generates the internal data in a low level when the number of high levels is even among logic levels of first and second selection data items.

22. The data recovery circuit of claim 21, wherein the data recovery unit comprises exclusive OR gates that receive first and second selection data items.
